(19) United States
(12) Patent Application Publication
(10) Pub. No.: US 2011/0131381 A1
(43) Pub. Date: Jun. 2, 2011

(54) CACHE SCRATCH-PAD AND METHOD THEREFOR

(75) Inventor: David A. Kaplan, Austin, TX (US)

(73) Assignee: ADVANCED MICRO DEVICES, INC., Sunnyvale, CA (US)

(21) Appl. No.: 12/626,826

(22) Filed: Nov. 27, 2009

(51) Int. Cl. G06F 12/08; G06F 12/14

(52) U.S. Cl. 711/141; 711/163; 711/E12.091; 711/E12.017

(57) ABSTRACT

An address containing data to be accessed is determined in response to executing an instruction received at a processor core of a microprocessor. During a scratch-pad mode of operation, it is determined whether a set of cache lines of a data cache is accessible based upon the memory location from which the instruction was retrieved. The address space of the data cache during scratch-pad mode can be isolated from other address spaces.

### BACKGROUND

1. Field of the Disclosure

The present disclosure relates generally to data processing devices, and more particularly to data processing devices having a cache memory.

2. Description of the Related Art

A data processing device may include registers to provide temporary storage of information, such as intermediate results of a calculation. For example, a task performed by a data processing device can include multiple calculations whereby data is manipulated pursuant to a procedure represented by a set of instructions included in a software program. The data processing device can execute the instructions and temporarily store intermediate results of a task at the registers, and later retrieve the results for use by one or more subsequent operations related to performing the task. Such registers are typically accessed directly by an execution unit of a processor core of data processing devices, such as integrated circuit microprocessors, and are accessed faster than other memory locations, such as memory locations external to the microprocessor core. Therefore, using registers can increase the speed at which tasks are executed. While it is desirable to increase the number of registers available to a processor core to increase the speed at which tasks can be performed, increasing the number of registers requires additional physical area that can result in additional costs. Therefore, a data processing device capable of implementing additional storage locations that can be accessed by the microprocessor core more quickly than external memory without increasing the number of registers would be useful.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a data processing device in accordance with a specific embodiment of the present disclosure.

FIG. 2 is a block diagram illustrating further details of a microprocessor core of the data processing device of FIG. 1 in accordance with a specific embodiment of the present disclosure.

FIG. 3 is a block diagram illustrating details of a load/store unit of the microprocessor core of FIG. 2 in accordance with a specific embodiment of the present disclosure.

FIG. 4 is a block diagram of a data cache memory in accordance with a specific embodiment of the present disclosure.

FIG. 5 is a flow diagram illustrating a method for operating the microprocessor core of FIG. 2 in accordance with a specific embodiment of the present disclosure.

FIG. 6 is a flow diagram illustrating a method for configuring and using the microprocessor core of FIG. 2 in accordance with a specific embodiment of the present disclosure.

FIG. 7 is a diagram illustrating a computer readable memory being used to configure fabrication equipment used to manufacture a device.

### DETAILED DESCRIPTION

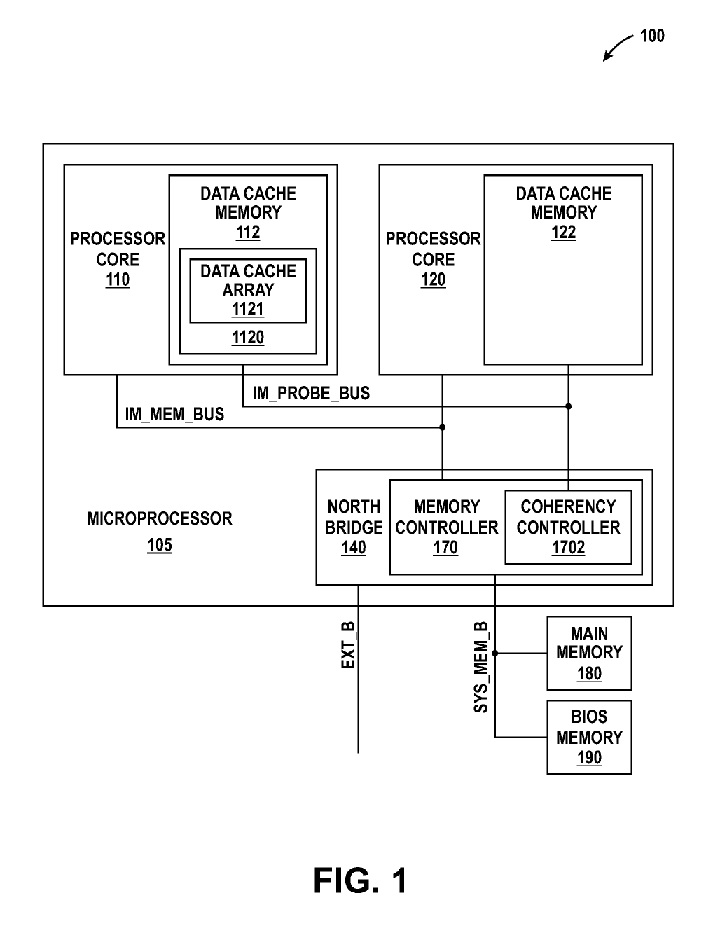

A data processing device and associated techniques are disclosed herein whereby a processor core can be configured to operate in a scratch-pad mode whereby a scratch-pad is maintained at a cache memory for access by the processor core in response to executing instructions stored at a defined location, such as at a particular memory or address range within a memory, while not allowing the scratch-pad to be accessed by the processor core in response to executing instructions that are not stored at the defined location. Various aspects of the present disclosure will be better understood with reference to FIGS. 1-6.

FIG. 1 is a block diagram illustrating a data processing device 100 in accordance with a specific embodiment of the present disclosure. Data processing device 100 can be a general purpose computer, such as a laptop computer or a server, a hand-held device, or any other device having the features described herein. Data processing device 100 includes a main memory 180, a basic input/output system (BIOS) memory 190, and data processing device 105, which is also referred to herein as microprocessor 105 (although other types of processor are possible embodiments). Data processing device 105 can be an integrated circuit processor that includes a plurality of modules, such as data processor core 110, data processor core 120, and an input/output controller 140, also referred to as northbridge 140.

Data processor core 110 includes a data cache memory 112. Data processor core 120 includes a data cache memory 122. Each of data cache memories 112 and 122 includes at least one level of data cache, and data cache 112 is specifically illustrated to include a first level data cache 1220, also referred to as an L1 Cache 1220. Northbridge 140 further includes a memory controller 170 that includes a coherency controller 1702, and a high speed external interface module (not shown) connected to an interconnect labeled EXT_B to support communication with other devices external to the data processing device 105 (not shown). An interconnect, labeled IM_MEM_B, is connected to processor core 110, processor core 120, and memory controller 170, and can be an intermodule bus having a plurality of conductive traces. An interconnect, labeled IM_PROBE_B, is connected to data cache 112, data cache 122, and coherency controller 1702. Memory controller 170 is connected to main memory 180 and BIOS memory 190 by an interconnect labeled SYS_MEM_B. The various interconnects disclosed herein are used to communicate information between various modules either directly or indirectly. For example, an interconnect can be implemented as a passive device, such as one or more conductive traces, that transmits information directly between various modules, or as an active device, whereby information being transmitted is buffered, e.g., stored and retrieved, in the processes of being communicated between devices, such as at a first-in first-out memory or other memory device. Data processing device 100 can include additional devices (not shown) such as hard-disk storage devices, graphic adapters, peripheral communication and interface devices, and the like.

BIOS memory 190 is configured to store instructions and data that are generally associated with initialization, configuration, and management of data processing device 100 and its individual devices including microprocessor 105. For example, instructions included at BIOS memory 190 can define procedures that initialize components of data processing device 100, such as integrated circuit microprocessor 105, to a known state, so that software, e.g. an operating system, can be loaded and executed to control operation of data processing device 100. BIOS memory 190 is generally implemented using non-volatile memory technology so that information stored therein is maintained when power is removed from data processing device 100. Main memory 180 is typically dynamic or static volatile memory, though non-volatile memory can also be used.

Northbridge 140 is a resource that is shared by each of data processor cores 110 and 120. Northbridge 140 may include other modules (not shown), such as a high-speed interconnect interface module, clock generators, peripheral control interface (PCI) registers, and the like. When either of data processor cores 110 or 120 needs to load information from an address location of main memory 180, or BIOS memory 190, a load request is provided by the requesting core to its respective local data cache memory and to memory controller 170. The local data cache of the requesting core will provide a hit indicator in response to the requested information being available, and in response the requesting core can cancel the load request provided to the memory controller 170. When a load request is received at memory controller 170 the coherency controller 1702 responds by broadcasting cache probes to each other data cache memory of data processor 105 that is not local to core providing the load request to determine if the requested information is available at an alternate cache location. Each other data cache memory responds to the cache probe with a hit or miss indicator that indicates whether the requested data is stored at the respective cache memory. Memory controller 170 fulfills the original memory access request from the requesting processor core with valid information that is provided by a data cache memory, if available, or from other memory, such as main memory 180, if the information is not available at a data cache memory. In this manner, a conventional cache configuration allows data caches of a processor device to act as a buffer for not only their local processor core, but for other processor cores as well by storing frequently and recently used information for subsequent retrieval.

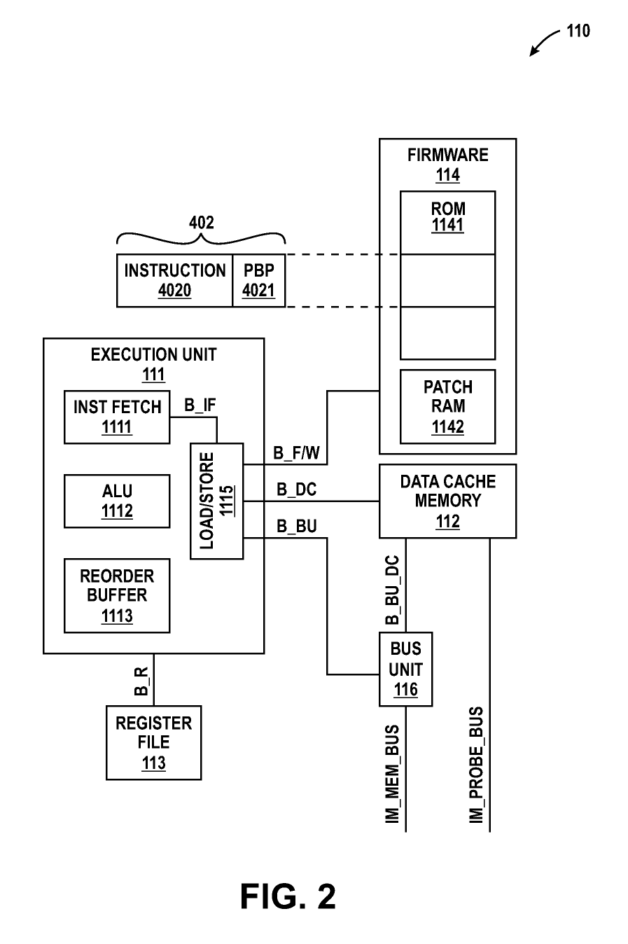

In addition to operating in a conventional manner, as described above, processor cores 110 and 120 can also operate in an alternate manner, referred to herein as scratch-pad mode, such that their respective data cache memory is dedicated to support data access requests associated with instructions stored at defined memory locations, as compared to conventional operation of the data cores, e.g., normal operation, whereby a processor core's cache can be accessed by an access request irrespective of the memory location from which a current instruction responsible for the access request is stored. Furthermore, the processor cores can be configured to respond to probe requests from coherency controller 1702 with a cache-miss indicator. By providing a cache miss indicator when the data cache 112 is a scratch-pad, the memory controller 170 will not erroneously identify scratch-pad information as being information relevant to access requests associated with instructions that cannot access the scratch-pad. In addition, the processor cores can be configured to operate in a manner whereby in response to a cache miss, a cache line of the scratch-pad implemented in its local data cache is filled with defined information, such as zeros (0), instead of filling the cache lines of the scratch-pad with information retrieved from memory controller 170. Various aspects of using a cache memory in a scratch-pad mode will be better understood with reference to FIGS. 2-6.

FIG. 2 is a block diagram illustrating further details of data processor core 110 of FIG. 1 in accordance with a specific embodiment of the present disclosure. Data processor core 110 includes an execution unit 111, a data cache memory 112, a register file 113, a firmware memory 114, and a bus unit 116. Execution unit 111 includes an instruction fetch module (INST FETCH) 1111, an arithmetic logic unit (ALU) 1112, a reorder buffer 1113, and a load/store unit 1115.

Execution unit 111 is connected to register file 113 via an interconnect labeled B_R. Load/store unit 1115 of the execution unit 111 is connected to firmware memory 114 via an interconnect labeled B_F/W, to data cache memory 112 via an interconnect labeled B_DC, and to bus unit 116 via an interconnect labeled B_BU. Data cache memory 112 is connected to bus unit 116 via an interconnect labeled B_BU_DC. In addition, bus unit 1116 is connected to interconnect IM_MEM_B, and data cache memory 112 is connected to interconnect IM_PROBE_B.

Firmware memory 114 includes a patch RAM 1142 and a ROM 1141 that can be accessed via interconnect B_F/W by load store unit 1115 to provide instructions to instruction fetch unit 1111 for decoding. Firmware ROM 1141 can be implemented using a read-only memory (ROM) 1141 that is manufactured to store instructions during the manufacturing of microprocessor 105. Patch RAM 1142 can be used to implement procedures and instructions not included at ROM 1141, and to modify or replace instructions included at ROM 1141. For example, patch RAM 1142 can be used to implement new instructions that are decoded by execution unit 111, to implement procedures based on instructions that can be executed by execution unit 111, and to provide modifications as to how existing instructions are handled in order to correct errors that may be detected after integrated circuit microprocessor 105 is manufactured. An example of a procedure that can be stored in firmware memory 114 is a device management procedure that supports initialization of devices at an integrated circuit microprocessor 105 in response to a reset operation in order to configure operation of peripheral devices such as a dynamic random access memory (DRAM) memory controller, to service interrupt requests, and the like. Patch RAM 1142 can be implemented using static RAM (SRAM) technology, NVRAM technology, or another suitable technology that supports write-accesses.

Entries in ROM 1141 and patch RAM 1142, such as entry 402, include an instruction field 4020 and a physical bypass (PBP) bit field 4021 that stores a bypass indicator. The PBP indicator generally indicates whether addresses associated with an instruction's instruction operands are to be handled as physical addresses or as virtual addresses that need to be translated to physical addresses.

Data cache memory 112 can be accessed via interconnect B_DC by load store unit 1115, as described in more detail herein, to determine if information needed by a current instruction, e.g., an instruction being executed at execution unit 111, is available at data cache memory 112. Bus unit 116 can be accessed by load store unit 115 via interconnect B_BU.

Register file 1113 can be accessed by the various modules of execution unit 111 via interconnect B_R.

In accordance with a specific embodiment, in response to a current instruction needing information associated with an external address, e.g., an address external to processor core 110, the load/store unit 115 will provide data access requests, e.g., load requests, to both the data cache memory 112 and the bus unit 115. The data cache memory 112 will provide a cache hit indicator to the load/store unit 112 in response to the information associated with the external address being available at data cache memory 112. The cache hit will result in the load/store unit 112 canceling the access request sent to bus unit 115. If the information associated with the address external processor core 111 is not available at data cache memory 112, the data cache memory 112 will send a cache miss indicator to the load/store unit 1115, and the load/store unit 1115 allows the corresponding access request sent to bus unit 116 to complete. In addition, in the event of a cache miss being detected at data cache memory 112, the data cache memory 112 and bus unit 116 can communicate via interconnect B_BU_DC to allocate and fill a cache line with the requested information, and with other information from external addresses that corresponds to addresses associated with the allocated cache line.

It is noted with respect to terminology used herein, that the same reference label can be used to refer to an interconnect, a signal transmitted via the interconnect, and information represented by the signal. For example, as used herein, it is proper to state that information IM_MEM_B is provided via interconnect IM_MEM_B, or that a signal IM_MEM_B transmitted via interconnect IM_MEM_B is received at bus unit 116.

During operation, procedures are implemented by execution unit 111, which retrieves and executes instructions identified by instruction fetch unit 1111 perform a desired task of a procedure. A retrieved instruction can include instruction operands that specify locations to which to store results (information resulting from the execution of the software instructions), that specify locations from which to fetch additional information to be used as data operands (information to be manipulated), that specify locations from which to fetch additional information that will be used to fetch additional information used to determine where data operands are stored, and to specify data operands. Register locations associated with instruction operands are accessed from register file 113 by the various modules of execution unit 111. Requests to non-register locations, such as for information from firmware 114 and memory locations not local to processor core 110 are handled by load/store unit 1115.

During operation, instructions retrieved from memory locations by load/store unit 1115 are provided to the instruction fetch unit 1111, which decodes the instructions and communicates to load/store unit 1115 the addresses where additional information needed to execute an instruction is stored. Once all data operands for an instruction are received at the instruction fetch module 1111, control passes to ALU 1112 to execute the command, thereby determining a result, if any. Results are handled by reorder buffer 1113, which stores results until the instruction responsible for the result is retired, e.g., until the instruction is authorized to be completed, at which time the reorder buffer 1113 will store the result at register 113, or communicate to the load store unit 1115 where to store the result.

It is typical for memory locations to store instructions that control operation of a data processor core. External memory locations, such as memories 180 and 190, typically include user instructions. Firmware memory 114 can include micro-code instructions, machine instructions, and user instructions. User instructions can be executed by execution unit 111 of data processor core 110 directly in hardware, or can first be decoded into one or more machine and micro-code instructions that are in-turn fetched from memory, e.g., firmware 114, and executed. Machine instructions can be executed by execution unit 111 directly in hardware, or can first be decoded into one or more machine and micro-code instructions that are in-turn fetched from memory and executed. Micro-code instructions are instructions that are typically executed by execution unit 111 directly in hardware.

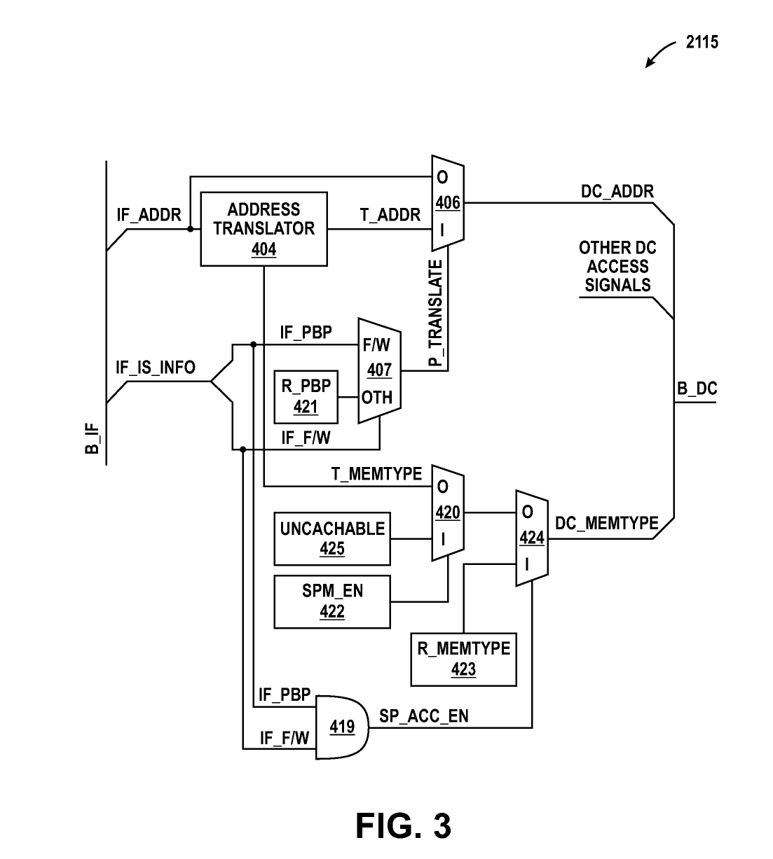

During scratch-pad mode of operation, information can be stored and retrieved from a defined set of cache lines of the data cache memory 112, referred to herein as a scratch-pad, only in response to the access requests being associated with a current instruction, e.g., an instruction currently executing at execution unit 111, that was retrieved from a defined memory location, such as from a selected specific range of addresses of a memory map, from a specific memory, e.g., firmware memory 114, the like, or combinations thereof. In contrast, during normal mode, information can be stored and retrieved from any of the cache lines of a data cache memory, including the cache lines used to implement the scratch-pad during scratch-pad mode, regardless as to from where the currently instruction was retrieved. The operation of core 110 during normal and scratch-pad mode will be better understood with reference to FIG. 3, which illustrates a specific implementation of a load/store unit, such as load store unit 1115.

FIG. 3 is a block diagram illustrating an embodiment of a load/store unit 2115 that is used to implement a scratch-pad mode of operation at processor core 110. Load/store unit 2115 includes: an address translator 404 connected to interconnects IF_ADDR, T_ADDR, and T_MEMTYPE; a multiplexer 406 having data inputs connected to interconnects IF_ADDR, and T_ADDR, a select input connected to interconnect P_TRANSLATE, and an output connected to interconnect DC_ADDR; a multiplexer 407 having data inputs connected to interconnect IF_PBP and to storage location 421, a select input connected to interconnect IF_F/W, and an output connected to interconnect P_TRANSLATE; a multiplexer 420 having data inputs connected to interconnect T_MEMTYPE and to storage location 425, a select input connected to storage location 422, and an output; a multiplexer 424 having data inputs connected to the output of multiplexor 420 and to storage location 423, a select input connected to interconnect SP_ACC_EN, and an output connected to interconnect DC_MEMTYPE; and a control module 419 having data inputs connected to interconnects IF_PBP and IF_F/W, and an output connected to interconnect SP_ACC_EN.

During scratch-pad mode of operation, the load/store unit 2115 interfaces with data cache memory 112 via interconnect B_DC to access a set of cache lines of cache memory 112, referred to as a scratch-pad, that can be only be accessed by access requests that are associated with the execution of instructions stored at firmware 114. Note that non-scratchpad portions of data cache memory 112, if any, can be accessed by instructions stored at either firmware or non-firmware locations during scratch-pad mode. In addition to allowing the scratch-pad to be accessed only by access requests associated instructions stored at firmware during scratch-pad mode of operation, the specific implementation of load/store unit 2115 allows an indicator associated with an instruction stored at firmware to further enable or disable a firmware instruction's ability to the scratch-pad. In the embodiment discussed herein, the set of cache lines making up the scratch-pad of cache memory 112 includes all of the cache lines of the L1 data cache 1121. Furthermore, it is presumed for purposes of discussion herein that data cache memory 112 includes only a single level of data cache, e.g., the L1 data cache 1121.

In response to executing a current instruction at execution unit 111 that has been retrieved from firmware or other memory, the instruction fetch module 1111 will provide and current access request to load/store unit 1115 via an interconnect B_IF for handling. Address information IF_ADDR and control information IF_IS_INFO are communicated by instruction fetch module 1111 via interconnect B_IF, and are used by load/store unit 115 to access cache 112 during normal mode, and to provide one of two possible access requests during scratch-pad mode based upon whether the current access request from the instruction fetch module 1111 is authorized to access the cache scratch-pad during scratch-pad mode. In the implementation specifically illustrated at FIG. 3, information IF_IS_INFO includes information IF_F/W and information IF_PBP. Information IF_F/W is an indicator that is asserted by instruction Fetch module 1111 in response to the instruction responsible for the current access request being associated with a firmware instruction, e.g., an instruction that was retrieved from firmware 114. Information IF_PBP is an indicator that is asserted by instruction Fetch module 1111 in response to the instruction responsible for the current access request being associated with an asserted physical bypass bit (PBP) 4021, as illustrated at FIG. 2.

Whether the processor core 110 is operating in a normal mode or a scratch-pad mode is determined by indicator SPM_EN at storage location 422, which can be a register of register file 113. Scratch-pad mode of operation is enabled in response to indicator SPM_EN being asserted, and normal mode is being implemented in response to indicator SPM_EN being negated.

During scratch-pad mode of operation, the information IF_IS_INFO is used by control module 419, which operates as a scratch-pad access control module, to determine if a current access request will be authorized to access the scratch-pad. During a non-scratch-pad mode of operation, the information IF_IS_INFO is used by control module 419 to determine whether the memory type of the memory being accessed is to be provided by address translator 404 or to be provided by a value stored at register 423, where a memory type indicates characteristics of a memory location being accessed, such as whether information stored at the location is cacheable or non-cacheable. Control module 419 is implemented at FIG. 3 as an AND gate to provide an asserted signal SP_ACC_EN in response to the current instruction being a firmware instruction, indicated by IF_F/W being asserted, and in response to the current instruction being also associated with an asserted PBP bit 4021, indicated by IF_PBP being asserted. Note that in accordance with a specific embodiment, only instructions stored at firmware locations, such as firmware 114, have corresponding bypass bits, whereby indicator IF_PBP can only be asserted if the current instruction was retrieved from firmware and has its associated PBP bit 4021 asserted. In all other instances, including when an instruction that did not originate in firmware, the indicator IF_PBP is negated.

Information IF_F/W and IF_PBP is also used to determine if an address provided by the instruction fetch module 1111 to the load/store unit 2115 is to be treated as a physical address that does not need to be translated, or as a virtual address that does need to be translated to obtain a physical address. For a current instruction fetched from firmware, an address associated with one of its instruction operands is identified as being physical addresses in response to its corresponding PBP bit being set. Therefore, an asserted signal IF_F/W, which indicates the current instruction was retrieved from firmware 114, results in the signal IF_PBP at the input F/W of multiplexor 407 being provided to the select input of multiplexor 406 as signal P_TRANSLATE to control operation of multiplexor 406. When P_TRANSLATE is asserted, e.g., a logic-level high, multiplexor 406 is configured to by-pass translating the address IF_ADDR by providing the information IF_ADDR to its output as signal DC_ADDR instead of the translated address T_ADDR from address translation 404. Therefore, when P_TRANSLATE is negated, e.g., a logic-level low, multiplexor 406 is configured to provide the translated signal T_ADDR to its output as signal DC_ADDR. When the current instruction originated at a memory other than firmware, the state of P_TRANSLATE is determined by a value R_PBP stored at register location 421, which can be set by a user or by execution unit 111 as part of implementing a particular instruction.

In addition to providing a translated address, T_ADDR, address translator 404 also provides a memory type indicator T_MEMTYPE that is associated with the translated address T_ADDR to an input of multiplexor 420. Multiplexor 420 also receives a memory type indicator UNCACHABLE_MT at another input, where indicator UNCACHABLE_MT is a memory type indicator stored at a location 425 that indicates that information associated with a particular address is not cacheable. The output of multiplexor 420 is connected to an input of multiplexor 424. A register 423 that can be programmed to store a memory type indicator R_MEMTYPE is connected to another input of multiplexor 424. The output of multiplexor 424 provides a memory type from load/store unit 1115, via interconnect DC_MEMTYPE, that is associated with the address DC_ADDR for current access request

During non-scratch-pad mode of operation, a negated signal SP_ACC_EN from control module 419 indicates that the translated address T_ADDR is the address to be used by load/store unit 2115 to request information from memory, and causes multiplexor 424 to provide at its interconnect DC_MEMTYPE the memory type indicator T_MEMTYPE, which corresponds to the memory type of the translated address T_ADDR. An asserted signal SP_ACC_EN from control module 419 during non-scratch-pad mode of operation indicates that the untranslated address IF_ADDR is the address to be used by load/store unit 2115 to request information from memory, and causes multiplexor 424 to provide at its interconnect DC_MEMTYPE the memory type R_MEMTYPE that is stored at register 423 during decoding, which corresponds to the memory type of the untranslated address IF_ADDR.

During scratch-pad mode of operation, multiplexor 420 is configured to provided memory type UNCACHEABLE from storage location 425 to the output of multiplexor DC_MEMTYPE. A negated signal SP_ACC_EN from control module 419 during scratch-pad mode of operation indicates that current access request is not authorized to access the cache scratch-pad, even though the cache is operating is scratch-pad mode, and causes multiplexor 424 to provide the indicator UNCACHEABLE at its output DC_MEMTYPE. Note that the current access request may not be authorized to access the cache-pad because it is associated with an instruction that is not stored at firmware, or because it is associated with a firmware instruction that did not have its indicator BPB asserted. An asserted signal SP_ACC_EN during scratch-pad mode of operation indicates that current access request is authorized to access the scratch-pad, e.g., the request is associated with a firmware instruction having its indicator BPB asserted, and causes multiplexor 424 to provide the memtype stored at register 423 at its output. The memtype stored at register 423 can be set by execution unit 111 as part of executing the current instruction.

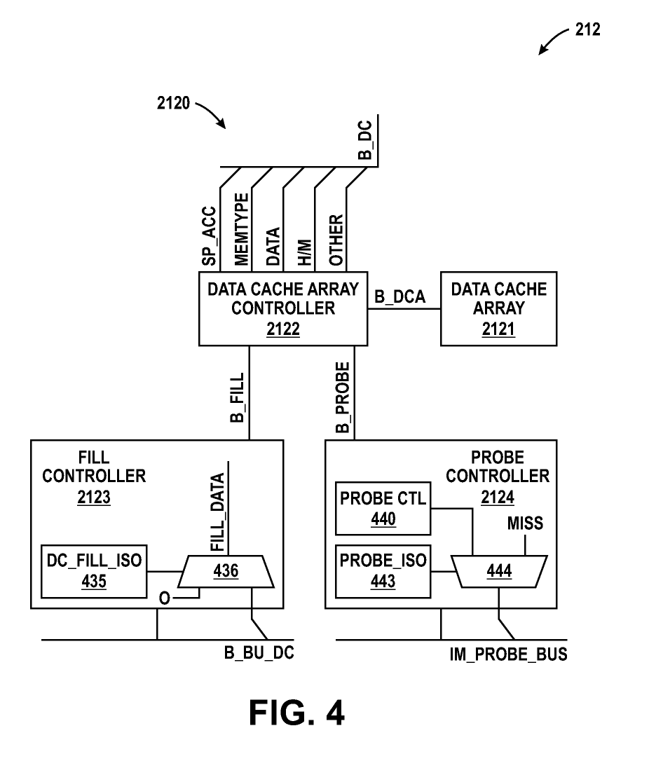

The memory type information at interconnects DC_MEMTYPE and DC_ADDR are combined with any other data cache access control signals (OTHER DC ACCESS SIGNALS) as interconnect B_DC and communicated to access data cache memory 112 as will be further described with reference to FIG. 4.

FIG. 4 illustrates a specific embodiment of a data cache 212, which can be an implementation of data cache 112, having a data cache level 2120, which for purposes of discussion is presumed to be the only level of data cache in data cache 212. Data cache level 2120 includes data cache array 2121, and various control modules including: data cache array controller 2122, fill controller 2123, and probe controller 2124. Data cache array controller 2122 communicates with load/store unit 1115 via interconnect B_DC. Data cache controller 2122 communicates with data cache array 2121 via interconnect B_DCA. Data cache controller 2122 communicates with probe controller via interconnect B_PROBE. Data cache controller 2122 communicates with fill controller 2123 via interconnect B_FILL. Fill controller communicates with bus unit 116 via interconnect B_BU_DC. Probe controller communicates with bus unit 2124 via IM_Probe_Bus.

As discussed with reference to FIG. 3, in response to the data cache 212 being operated in a scratch-pad mode of operation, and in response to a firmware instruction being executed that has its physical bypass bit 4021 asserted, a memory type stored at register 423 will be provided to the data cache array controller 2122. The memory type stored at register 423 can be stored by execution unit 111 as part of execution of the current instruction and will be cacheable memory type indicator that indicates information at the current address is cacheable. In response to the current address being cacheable, data cache array controller 2122 will access the scratch-pad, e.g., data cache array 1121, in a normal manner, albeit during scratch-pad mode of operation, to retrieve and store information. Therefore, if the current address is not represented at the data cache array 2121 a cache miss results, and a cache line of the data cache array can be filled as described in greater detail below. Conversely, if the current address is represented at the data cache array 2121 a cache hit results, and a cache line of the data array will be accessed to store or return the information associated with the access request.

In response to the data cache 212 being operated in scratch-pad mode of operation, and in response to a non-firmware instruction being executed or a firmware instruction being executed that does not have its physical bypass bit 4021 asserted, the memory type indicator provided from the load/store unit via interconnect MEMTYPE will always be an uncacheable memory type, which indicates that the information associated with the current address is uncacheable at cache level 2120. As a result of the uncacheable memory type, the data cache array controller 2122 will not allow information from data cache array 2121 to be provided to interconnect B_DC, to be received from interconnect B_DC, nor will the data cache array controller 2122 allow data cache array 1121 to be filled by the fill controller 2123 when the requested information is returned from other memory via bus unit 116.

Fill controller 2123 is associated with a storage location 435, which can be a register location that stores an indicator DC_FILL_ISO. When DC_FILL_ISO is asserted, fill controller 2123 is prevented from filling a cache line of data cache array 2121 with information retrieved from external memory in response to a cache miss. Instead, in response to a miss at data cache array 2121, the data cache array 1121 receives information from fill controller 2123, e.g., is filled by fill controller 2123, having a defined value, such as zero (0). Conversely, when DC_FILL_ISO is negated, a cache line of data cache array 1121 is filled by fill controller 2123 by communicating with memory controller 170 via interconnect IM_MEM_BUS to obtain the requested data and other non-requested data from external memory as needed to fill a cache line of data cache array 2121.

Probe controller 2124 is associated with a storage location 443, which can be a register location, that stores an indicator PROBE_ISO, and communicates with coherency controller 1702 via interconnect IM_PROBE_BUS. When PROBE_ISO is asserted, probe controller is prevented from providing responses to probe requests that are based upon the contents of data cache array 2121. For example, when PROBE_ISO is asserted, probe controller 2124 can be configured to always provide a probe miss indicator in response to a probe request. Conversely, in response to data cache memory 112 operating with PROBE_ISO negated, probe controller 440 interfaces with data cache array 1121 to determine whether to provide a cache-hit or a cache-miss indicator at interconnect IM_PROBE_BUS based on whether information being requested via interconnect IM_PROBE_BUS is currently available at data cache array 1121. It will be appreciated that typically PROBE_ISO will be asserted during scratch-pad mode, e.g., when SPM_EN is asserted, to allow the address space of the scratch-pad to be isolated from other address spaces that are external to processor core 110, thereby allowing the same address space to reside in both the scratch-pad and in the external address space, e.g., the cache-pad address space is isolated from the external address space.

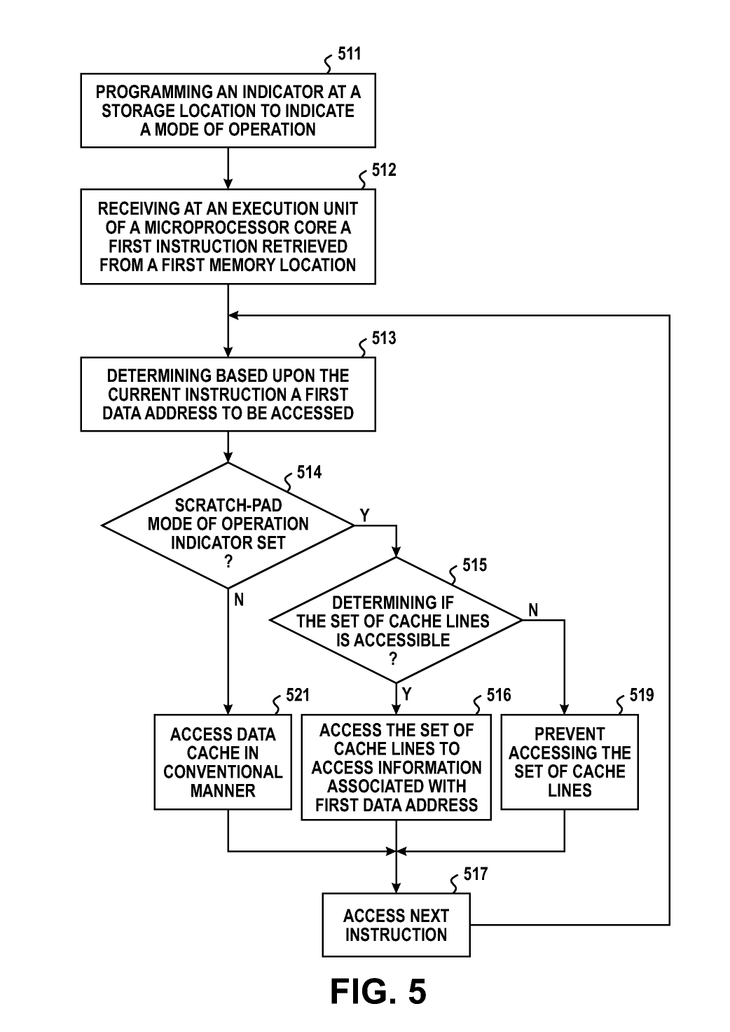

FIG. 5 illustrates a flow diagram of a method in accordance with a specific embodiment of the present disclosure that can restrict access to a portion of a cache memory by a data access request associated with an instruction responsive to a memory location storing the instruction. At node 511 a configuration setting is programmed at an integrated circuit device to indicate a specific mode of operation. The configuration setting can include one or more variables representing various indicators, such as indictors SPM_EN, DC_FILL_ISO, and PROBE_ISO, as previously described. For example, variable SPM_EN at storage location 422 can be a bit that is asserted to indicate that a processor core is operating in scratch-pad mode, whereby a data cache associated with the processor core is accessed in such a manner that the data cache includes a scratch-pad. Alternatively, variable SPM_EN can be negated to indicate that the processor core is operating in a non-scratch-pad mode, whereby the data cache is accessed in a conventional manner such it does not include a scratch-pad. Variable DC_FILL_ISO can be asserted to indicate that a data cache is isolated in a manner to prevent data stored at other memory locations from being used to fill cache lines of the data cache. Variable PROBE_ISO can be asserted to indicate that the data cache is isolated in a manner whereby a cache miss is always returned in response to a cache probe. Therefore, responses to probe requests are not based upon information stored at the data cache array 2121. It will be appreciated that in other embodiments, a single variable, such as SPM_EN can be used to enable the use of both scratch-pad and isolation features. For example, the variable SPM_EN can be used to indicate that the data cache contains a scratch-pad, that the fill controller is prevented from providing data stored at other memory locations to the data cache, and that a cache miss is to be provided in response to a cache probe.

At node 512, an instruction is received at an execution unit of a microprocessor core from a memory location. The memory location from where the instruction was received can be a location associated with specific memory device, such as firmware 114, main memory 180, or bios memory 190. The memory location from where the instruction is received can also be a location associated with an address range, which can reside at one or more memory devices.

At node 513, a data address to be accessed is determined based upon execution of the current instruction. For example, an instruction operand of the current instruction, e.g., the instruction received at node 512, can identify a data address from which a data operand is to be accessed by an execution unit as part of executing the current instruction, or the current instruction can identify a data address to which a result is to be stored.

At node 514, a determination is made based upon the indicator programmed at node 511 whether the processor core is in a scratch-pad mode of operation. The scratch-pad indicator can be a single bit of one or more bits programmed at node 511. Flow proceeds to node 515 in response to being in scratch-pad mode of operation, otherwise flow proceeds to node 521.

At node 515, a determination is made whether a set of cache lines of a data cache representing a scratch-pad is accessible by a current access request of the execution unit. As discussed previously, whether the scratch-pad memory is accessible by an access request can be based upon one or more criteria. For example, determining the scratch-pad is accessible to an access request can be based upon whether the current instruction responsible for the access request was fetched from a defined location, such as firmware memory, and whether the current instruction is also associated with an asserted indicator, such as an asserted PBP bit 4021, which further enables the scratch-pad to be accessed. It will be appreciated that other indicators can be used to authorize access to the scratch-pad, for example, an indicator can be based upon whether the address of an access request is within a defined address range, whereby the scratch pad can only be accessed in response to an access request associated with firmware instructions that are within the defined address range. Such a range of data addresses can be software programmable. Flow proceeds to node 516 in response to determining the set of cache lines is accessible, otherwise, flow proceeds to node 519.

At node 516, the scratch-pad is accessed, whereby information stored at the scratch-pad can be retrieved, e.g., provided to the execution unit, in response to determining the set of cache lines is accessible. Similarly, information can be stored at the set of cache lines in response to determining the set of cache lines is accessible. The information can be stored as a result of being provided from a load/store unit of an execution unit, or stored as a result of being retrieved by a fill controller in response to a cache miss. Flow proceeds to node 517 from node 516. At node 517, a next instruction is received at the execution unit and flow returns to node 513.

If at node 515 it is determined that the set of cache lines is not accessible, for example, when the current firmware instruction is associated with a negated PBP bit as described previously, flow proceeds to node 519. At node 519, access of the scratch-pad is prevented. For example, information stored at the scratch-pad cannot be provided to the execution unit in response to determining at node 515 that the set of cache lines is not accessible. Instead, the information needs to be retrieved from other non-scratch-pad portions of cache memory, if any, or from external memory locations. Similarly, information cannot be stored at the set of cache lines in response to determining at node 515 the set of cache lines is accessible. Flow proceeds to node 517 from node 519.

If at node 514 it was determined based on the indicator programmed at node 511 that the processor core is not in the scratch-pad mode of operation, flow proceeds to node 521. At node 521, it is determined that access to all cache lines of the data cache, including is allowed, including the portion that is a scratch-pad during scratch-pad mode of operation, in a conventional manner. Flow proceeds to node 517 from node 521.

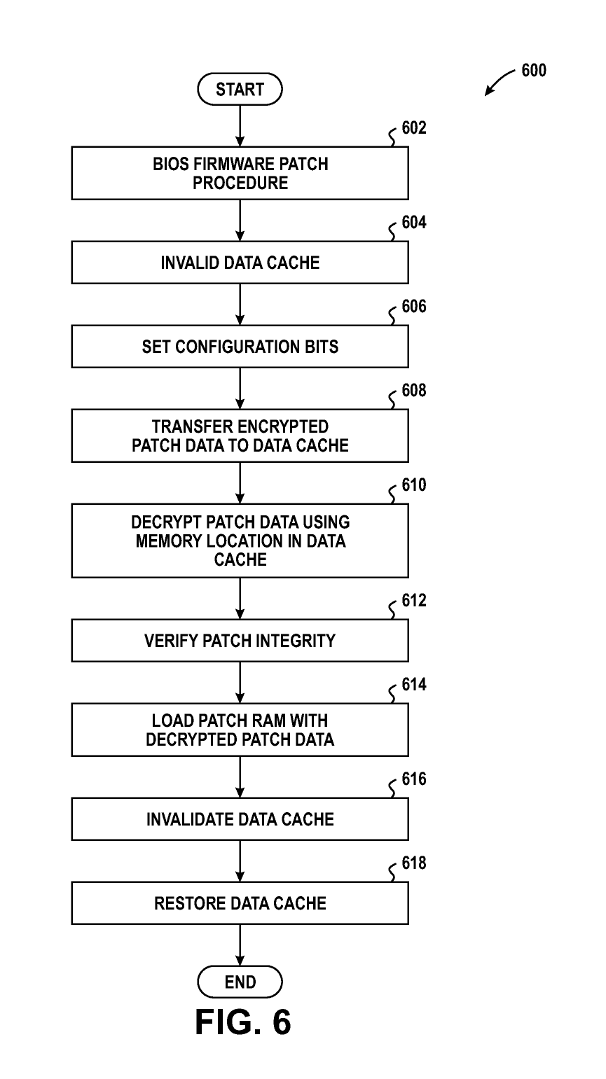

FIG. 6 is a flow diagram illustrating a procedure 600 for configuring and using data cache memory 112 of FIG. 2 as a scratch-pad memory in accordance with a specific embodiment of the present disclosure whereby an encrypted firmware patch stored in main memory 180 can be loaded into the scratch-pad and be decrypted in a secure manner. Method 500 begins at node 602 where execution of a procedure, which can be stored at BIOS memory 190, initiates execution of a firmware patch procedure stored at firmware 114. In an embodiment, the branch to the firmware patching procedure is initiated by performing a write operation to a model specific register (MSR) associated with the firmware patching program that identifies the location at main memory 180 where the encrypted patch information is stored.

The flow proceeds to node 604 where the firmware program invalidates data at the scratch-pad of cache memory 112 by requesting coherency controller 1702 to write-back data that is exclusively stored at the scratch-pad of data cache memory 112 to main memory 180 and to flush a translation look-aside buffer, not shown, at address translator 406. This operation can be accomplished using conventional write-back invalidation protocols supported by a normal data cache memory, such as data cache memory 112, and initiated by instructions executed from firmware memory 114.

The flow proceeds to node 606 where data cache memory 112 is configured to operate in a scratch-pad mode by setting bits SMP_EN, DC_FILL_ISOLATE, and PROBE_ISO. The flow proceeds to node 608 where the encrypted firmware patch data located at physical memory 180 is loaded into data cache memory 112. In an embodiment, the encrypted patch data is loaded via register file 113. For example, each word of encrypted patch information stored at memory 180 can be loaded at a register of register file 113 by executing a load instruction from firmware 114 that has its PBP bit negated. As a result, the encrypted patch information is loaded at an indicated register location, while being prevented from being stored at the scratch-pad as a result of the PBP bit being negated. Next, the encrypted patch information stored at the register of register file 113 is stored at the scratch-pad of the data cache by executing a store instruction fetched from firmware 114 that has its PBP bit asserted. As a result, the encrypted patch information is stored at a cache line of the scratch-pad. If the address specified by the instruction is not yet associated with a cache line of the scratch-pad, the data cache will allocate a cache line by writing an appropriate value to the tag associated with the cache line. In response to DC_FILL_ISO being asserted, the fill controller 2123 will subsequently fill the remaining locations of the newly allocated cache line with zeros, as previously described. By repeating these steps, encrypted patch information can be loaded from main memory 180 to a scratch-pad implemented at a data cache.

The flow proceeds to node 610 where the firmware program decrypts the encrypted patch data currently residing in the scratch-pad. This is accomplished by the firmware program issuing load and store instructions having instruction operands representing physical addresses that correspond to the addresses represented at the scratch-pad of data cache memory 112. Note that store instructions from firmware having their bypass bits set result in new cache lines being allocated as needed. The flow proceeds to node 612 where the integrity of the decrypted patch data is verified using an integrity check, such as a cyclic redundancy check (CRC) algorithm. In an embodiment, the decryption and verification steps can be performed on nodes of patch data wherein the complete set of patch data includes one or more nodes. The flow proceeds to node 614 where the decrypted patch data is transferred from data cache memory 112 to patch RAM 1141 by executing a store instruction.

Once patch RAM 1141 has been fully updated and data cache memory 112 is no longer needed for use as a scratch-pad memory, the flow proceeds to node 616 where data associated with the patching process that may still be present at data cache memory 112 is invalided by clearing valid bits associated with each entry at data array 2121, and overwriting the contents for further security, if desired. This further ensures that the entire decryption and patching process is performed with substantial security to prevent tampering with firmware information by other software processes, such as software programs resident at BIOS memory 190. The flow proceeds to node 618 where data cache memory 112 is restored to a normal operating mode representative of its configuration before transitioning to operating in a scratch-pad mode by resetting configuration bits SPM_EN, DC_FILL_ISO, and PROBE_ISO. Note that the contents of data cache memory 112 (previous to being configured to operate in scratch-pad mode) are not restored, but the previous information is available at main memory 180 or at another cache memory. Thus, data cache memory 112 can be configured to operate in a scratch-pad mode independent of a virtual address mapping, cache coherency protocol, and other operating settings established by the BIOS software, and these settings remain unchanged when data cache memory 112 is subsequently configured to operate in a normal mode.

Therefore, during scratch-pad mode, the firmware procedure can make use of the relatively large number of storage locations available at the data cache memory to perform the data decryption operation, while the data cache memory provides a secure location to perform the decryption and patching operation in that attempts to access the data cache memory from a location other than the defined memory location, such as firmware, memory are denied. For example, when the data cache memory is configured to operate in the scratch-pad mode a load or store instruction executing at another data processor core or from a memory location other than the defined memory location is prevented from accessing the data cache memory, and must instead access non-scratch-pad cache memory, or a main memory device. In addition, the data cache memory can further isolate the scratch-pad memory by limiting access and visibility to the data cache while in scratch-pad mode, such as by limiting the ability to fill a cache line with information external the data cache memory and by limiting responses to probe requests.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

For example, wherein techniques disclosed herein have been described in the context of configuring a data cache memory for use as a scratch-pad by a program executing at a firmware memory, and specifically to provide temporary storage to facilitate decrypting firmware patch information and loading a firmware patch ram with the decrypted patch information, the data cache memory can be configured provide scratch-pad access to another source for another purpose. For example, scratch-pad access to the data cache memory can be provided to one or more memory devices, or to accesses associated with a predetermined set of addresses. For example, a data cache memory can be configured to operate as a scratch-pad and accessible to a software program executing out of Main memory 180 or BIOS memory 190 to facilitate secure execution of a sensitive operation (such as a data decryption operation). In addition, it will be appreciated for a data cache having multiple cache levels that the scratch pad can be limited to one level or cache or can span multiple levels of caches. For example, multiple scratch-pad indicators could be used to indicate which cache levels of a data cache are to be implemented as a scratch-pad. Those cache levels not implemented as a scratch-pad would be subject to being accessed in a normal manner.

As discussed above, one aspect of the present disclosure discloses receiving at a processor core of a processor a first instruction retrieved from a first memory location. In response to executing the first instruction, it is determined at the first processor core a first data address to be accessed, and it is determined at the first processor core based upon the first memory location whether a set of cache lines of a data cache at the processor core is accessible to an access request.

In accordance with an embodiment of this aspect, determining whether the set of cache lines is accessible to an access request includes determining whether information stored at the set of cache lines can be retrieved from the data cache in response to a load request, and the embodiment includes accessing the data cache to retrieve information associated with the first data address at the set of cache lines in response to determining that the set of cache lines is accessible.

In accordance with another embodiment of this aspect, determining whether the set of cache lines is accessible to an access request includes determining whether information can be stored at the set of cache lines of the data cache in response to a store request, and the embodiment includes accessing the data cache to stored information at a cache line of the set of cache lines that is associated with the first data address in response to determining that the set of cache lines is accessible.

In accordance with another embodiment of this aspect, determining whether the set of cache lines is accessible is further in response to an indicator indicating that the data cache includes a scratchpad, and the embodiment includes, in response to the indicator indicating that the data cache does not include a scratchpad, determining that the set of cache lines is accessible. In one implementation this embodiment includes programming the indicator to indicate one of that the data cache includes the scratchpad or that the data cache does not include the scratchpad. In another implementation this embodiment includes responding to probe requests with information not based upon the content of the set of cache lines of the data cache. In another implementation this embodiment includes filling a cache line, of the set of cache lines, that is associated with an address range with predetermined information not associated with information stored at the address range.

In accordance with another embodiment of this aspect, determining whether the set of cache lines is accessible is further based upon whether the first memory location is at a firmware memory of the processor core. In one implementation this embodiment includes determining whether the set of cache lines is accessible is further based upon determining whether the first memory location is within a defined address range. In another implementation this embodiment includes determining whether the set of cache lines is accessible is further based upon an indicator associated with the first instruction, wherein the indicator is stored at a bit location within the firmware memory that is exclusively associated with the first instruction. In another implementation this embodiment includes the first data address being identified by an instruction operand of the first instruction, and the method further including preventing use of a virtual to physical translation of the first data address from a translation module in response to the indicator being asserted.

In accordance with another embodiment of this aspect, determining whether the set of cache lines is accessible is further based upon whether the first data address is within a defined address range.

In accordance with another embodiment of this aspect determining whether the set of cache lines is accessible is further based upon whether the address of the first data address is within a defined address range.

Another aspect of the present disclosure includes executing a program stored at firmware, wherein executing the program comprises: retrieving at a core of a processor a first instruction from the firmware; determining a first data address is to be accessed in response to executing the first instruction; determining in response to the first instruction being stored at the firmware and based upon a state of an indicator associated with the first instruction whether a set of cache lines of a data cache is accessible; preventing access to the set of cache lines in response to the data cache is not accessible; retrieving at the core of the processor a second instruction from the firmware; determining, a second data address is to be accessed in response to executing the second instruction; determining in response to the second instruction being stored at the firmware and based upon an indicator associated with the second instruction whether the set of cache lines of the data cache is accessible; and accessing the set of cache lines in response to determining the data cache is accessible.

In accordance with an embodiment of this aspect the program includes instructions to load encrypted information into the set of cache lines, to determine unencrypted information based upon the encrypted data, and to load the unencrypted information into a firmware patch memory of the core.

Another aspect of the present disclosure includes a device comprising: a first memory; and a processor core coupled to the first memory, the processor core comprising: a firmware memory; an execution unit coupled to the firmware memory and to the first memory, the execution unit to execute instructions retrieved from memory locations of the first memory and the firmware memory; a data cache coupled to the execution unit to receive a cache access request based upon the execution of a current instruction; and the processor core comprising a control module to determine, based upon a memory location of the first memory from the current instruction was retrieved, whether the data cache is authorized to access a set of cache lines.

In accordance with an embodiment of this aspect the device further includes a storage location for storing a first indicator associated with a first instruction that is stored at the firmware memory, the first indicator to indicate whether the first instruction is authorized to access the set of cache lines; and wherein in response to the current instruction being the first instruction, the control module is to determine that the data cache is authorized to access the set of cache lines in response to the current instruction being retrieved from the firmware memory and the first indicator indicating that the first instruction is authorized to access the set of cache lines. In one implementation of this embodiment, the device includes a storage location for storing a second indicator to indicate the processor core is operating in one of a first mode of operation or a second mode of operation; and wherein in response to the processor core being in the second mode of operation the control module is operable to determine whether the data cache is authorized to access the set of cache lines, and in response to the processor core being in the second mode of operation the control module is to determine that the data cache is authorized to access the set of cache lines. With respect to this implementation the data cache includes a probe port to receive probe requests, the data cache further to provide responses to the probe requests that are not based upon a content of the data cache in response to the second indicator indicating the second mode of operation, and to provide responses to the probe requests that are based upon the content of the data cache in response to the second indicator indicating the first mode of operation.

In accordance with an embodiment of this aspect the control module is to determine whether the set of cache lines is accessible based upon whether the memory location is a memory location of the firmware memory.

Another aspect of the present disclosure includes a method of data processing comprising to restrict access to a portion of a cache memory by a data access request associated with an instruction responsive to a memory location storing the instruction.

Another aspect of the present disclosure includes a device that includes a processor core including a cache memory coupled to an execution unit, the processor core to restrict access to a portion of the cache memory by a data access request associated with an instruction executing at the execution unit responsive to a memory location storing the instruction.

Another aspect of the present disclosure includes a computer readable memory storing data representative of a set of instructions that when executed are adapted to configure a processor to restrict access to a portion of a cache memory by a data access request associated with an instruction responsive to a memory location storing the instruction. According to one aspect of the present disclosure, the set of instructions are Hardware Description Language instructions that configure the processor by adapting a manufacturing process to facilitate formation of the processor.

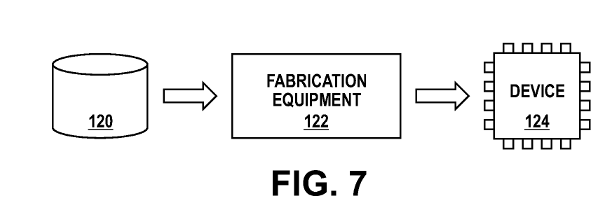

It will be appreciated that various aspects of the present disclosure can be implemented in both hardware and software. For example, in one embodiment a computer usable (e.g., readable) memory is configured to store instructions (e.g., a computer readable program code) that can implement various aspects of the present disclosure including the following embodiments: (i) configuration of a data processor to implement the functions disclosed herein, such as methods that configure a processor to restrict access to the cache as disclosed herein; (ii) the fabrication of the devices disclosed herein as described further below with reference to FIG. 7, such as devices that restrict access to the cache as disclosed herein; and (iii) a combination of the methods and fabrication of the devices and methods disclosed herein.

FIG. 7 illustrates use of a computer readable memory in the fabrication of a device as disclosed herein. A computer readable memory 720, such as a semiconductor, magnetic disk, optical disk, optical, or analog-based medium, stores Hardware Description Language (HDL) instructions. The HDL instructions can include, but are not limited to, Verilog or another hardware representation for implementing various aspects disclosed herein. The HDL instructions can be used to configure various processes and equipment 722 used to manufacture a device 724. The device 724 may be an integrated circuit fabricated using fabrication equipment, such as the type of equipment found in mask fabrication and semiconductor fabrication facilities, for example.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method of data processing comprising: restricting access to a portion of a cache memory by a data access request associated with an instruction responsive to a memory location storing the instruction.

2. The method of claim 1, wherein the restricting access to the portion of the cache memory is further responsive to an indicator indicating that cache memory includes a scratchpad.

3. The method of claim 2, further comprising programming the indicator to indicate one of the cache memory includes the scratchpad, or the cache memory does not include the scratchpad.

4. The method of claim 2, further comprising:
restricting use of content of the portion of the cache memory when responding to a probe request by the cache memory.

5. The method of claim 2, wherein the data access request is a first data access request, the instruction is a first instruction, and the method further comprises:
allowing access to the portion of the cache memory by a second data access request associated with a second instruction, the allowing access responsive to a memory location storing the second instruction; and
associating a cache line of the portion of the cache memory with an address range including an address of the second data access request, and filling the cache line with predetermined information not associated with information stored at the address range.

6. The method of claim 1, wherein the memory location is a firmware memory.

7. The method of claim 6, wherein restricting access further includes restricting access responsive to an indicator, stored at a location within the firmware memory, that is exclusively associated with the instruction.

8. The method of claim 6, wherein the data access request is associated with a data address identified by an instruction operand of the instruction, and the method further comprising:
preventing use of a virtual to physical translation of the first data address responsive to the indicator being asserted.

9. The method of claim 1, wherein the memory location is a selected address range of a firmware memory.

10. The method of claim 1, wherein the memory location is a selected address range.

11. The method of claim 1, wherein restricting access further includes restricting access responsive to a data address associated with the data access request.

12. The method of claim 1, wherein the data access request is a load request.

13. The method of claim 1, wherein the data access request is a store request.

14. A computer readable memory storing data representative of a set of instructions that, when executed, are adapted to configure a processor to restrict access to a portion of a cache memory by a data access request associated with an instruction responsive to a memory location storing the instruction.

15. The computer readable memory of claim 14, wherein the set of instructions are Hardware Description Language instructions that configure the processor by adapting a manufacturing process to facilitate formation of the processor.

16. A device comprising: a processor including a cache memory coupled to an execution unit, the processor to restrict access to a portion of the cache memory by a data access request associated with an instruction executing at the execution unit, the restricted access responsive to a memory location storing the instruction.

17. The device of claim 16, wherein the memory location is a firmware memory of the processor.

18. The device of claim 16, further comprising:
a first storage location for storing a first indicator to indicate whether the processor is operating in a first mode of operation or a second mode of operation; and
wherein the processor further is to restrict access responsive to the processor being in the first mode of operation and not the second mode of operation.

19. The device of claim 18, further comprising:
a second storage location for storing a second indicator associated with the instruction to indicate whether the instruction is authorized to access the portion of the cache memory; and
wherein the processor further is to restrict access responsive to the second indicator.

20. The device of claim 16 wherein the memory location is an address range.
